(19) United States
(12) Patent Application Publication
(10) Pub. No.: US 2024/0357448 A1
(43) Pub. Date: Oct. 24, 2024

(54) RELAY SELECTION OR RESELECTION METHOD, APPARATUS AND SYSTEM

(71) Applicant: FUJITSU LIMITED, Kawasaki-shi Kanagawa (JP)

(72) Inventors: Guorong LI, Beijing (CN); Meiyi JIA, Beijing (CN); Xin WANG, Beijing (CN)

(73) Assignee: FUJITSU LIMITED, Kawasaki-shi Kanagawa (JP)

(21) Appl. No.: 18/757,796

(22) Filed: Jun. 28, 2024

Related U.S. Application Data
(63) Continuation of application No. PCT/CN2022/070688, filed on Jan. 7, 2022.

(51) Int. Cl. H04W 36/00; H04W 36/30; H04W 88/04

(52) U.S. Cl. CPC H04W 36/033; H04W 36/30; H04W 88/04

(57) ABSTRACT

An apparatus, configured in a first terminal equipment, wherein the apparatus includes: communicator configured to communicate a second terminal equipment via a relay device; and processor circuitry configured to trigger a selection process of the relay device or a reselection process of the relay device in a first situation.

### CROSS-REFERENCE TO RELATED APPLICATION

This application is a continuation application of International Application PCT/CN2022/070688 filed on Jan. 7, 2022, and designated the U.S., the entire contents of which are incorporated herein by reference.

### FIELD

The present application relates to the field of communications.

### BACKGROUND

In the Release 17, UE-to-UE relay is studied, which can extend the coverage of the side link transmission between two side link UEs and save power.

FIG. 1 is a schematic diagram of the UE-to-UE relay scenario. As shown in FIG. 1, in one scenario, all UEs (including a source UE 11, a relay UE 12, and a destination UE 13) are within the coverage of the network; in another scenario, all UEs are outside the coverage of the network; in yet another scenario, at least one UE is within the coverage of the network and at least one UE is outside the coverage of the network, this scenario is also called a partial coverage scenario. FIG. 2 is a schematic diagram of a network architecture of the scenario shown in FIG. 1.

It should be noted that, the above introduction to the background is merely for the convenience of clear and complete description of the technical solution of the present application, and for the convenience of understanding of persons skilled in the art. It cannot be regarded that the above technical solution is commonly known to persons skilled in the art just because that the solution has been set forth in the background of the present application.

### SUMMARY

The inventor finds that the related art only specifies a case in which a remote UE triggers relay selection or reselection in a UE-to-Network relay scenario. In the UE-to-UE relay scenario, the signal strength of the Uu interface or communication with the network is not involved. Therefore, some cases in the related art that relay selection or reselection is triggered are not applicable to the triggering of relay selection or reselection by a source UE and/or a destination UE in the UE-to-UE relay scenario.

Regarding the above or other similar problems, embodiments of the present application provide a relay selection or reselection method, an apparatus and a system.

According to an aspect of an embodiment of the present application, there is provided with a relay selection or reselection apparatus, configured in a first terminal equipment, the apparatus includes:
a triggering unit configured to, in a UE-to-UE relay scenario, trigger selection or reselection of a relay device in at least one of the following situations:
a PC5 signal strength between the first terminal equipment and a second terminal equipment being lower than a first signal strength threshold;
the first terminal equipment detecting a radio link failure (RLF) of PC5 interface between the first terminal equipment and a second terminal equipment;
an upper layer indication;
an indication from a first relay device;
a PC5 signal strength between the first terminal equipment and a second relay device being lower than a second signal strength threshold;
the first terminal equipment receiving a PC5-S link release message from the second relay device;
the first terminal equipment detecting a radio link failure (RLF) of PC5 interface between the first terminal equipment and the second relay device;
an indication from the second relay device;
an indication from a third relay device;
an indication from the second terminal equipment; and
a PC5 signal strength between the first terminal equipment and the third relay device being higher than a seventh signal strength threshold;
wherein, the first relay device is a candidate relay device, the second relay device is a current relay device via which the first terminal equipment communicates with the second terminal equipment, and the third relay device is another relay device than the current relay device via which the first terminal equipment communicates with the second terminal equipment.

According to another aspect of the embodiment of the present application, there is provided with a relay selection or reselection apparatus, configured in a relay device, the apparatus includes:
an indicating unit configured to, in a UE-to-UE relay scenario, indicate a first terminal equipment to perform relay selection or reselection in at least one of the following situations:
a PC5 signal strength between the relay device and the first terminal equipment being higher than a third signal strength threshold, the relay device being a candidate relay device;
a PC5 signal strength between the relay device and a second terminal equipment being higher than a fourth signal strength threshold, the relay device being a candidate relay device;
the relay device detecting an RLF of PC5 interface or PC5-RRC connection between the relay device and a second terminal equipment, the relay device being a current relay device via which the first terminal equipment communicates with the second terminal equipment;
a PC5 signal strength between the relay device and the second terminal equipment being lower than a fifth signal strength threshold, the relay device being a current relay device via which the first terminal equipment communicates with the second terminal equipment;
the relay device determining that the second terminal equipment performs or is about to perform relay device reselection, the relay device being a current relay device via which the first terminal equipment communicates with the second terminal equipment;
a PC5-S link between the relay device and the second terminal equipment being released, the relay device being a current relay device via which the first terminal equipment communicates with the second terminal equipment;
the relay device determining that a PC5 signal strength between another relay device and the second terminal equipment being higher than a fourth signal strength threshold or a sixth signal strength threshold, the relay device being a current relay device via which the first terminal equipment communicates with the second terminal equipment;
a PC5 signal strength between the relay device and the first terminal equipment being higher than a seventh signal strength threshold, the relay device being another relay device than a current relay device via which the first terminal equipment communicates with the second terminal equipment; and
a PC5 signal strength between the relay device and the second terminal equipment being higher than the sixth signal strength threshold, the relay device being another relay device than a current relay device via which the first terminal equipment communicates with the second terminal equipment.

According to a further aspect of an embodiment of the present application, there is provided with a relay selection or reselection apparatus, configured in a second terminal equipment, the apparatus includes:
an indicating unit configured to, in a UE-to-UE relay scenario, indicate a first terminal equipment to perform relay selection or reselection in at least one of the following situations:
end-to-end PC5-RRC connection or a PC5 link between the first terminal equipment and the second terminal equipment being released;
the second terminal equipment performing or being about to perform relay device selection or reselection; and
a PC5 signal strength between a third relay device and the second terminal equipment being higher than a sixth signal strength threshold;
wherein the third relay device is another relay device than a current relay device via which the first terminal equipment communicates with the second terminal equipment.

One of the beneficial effects of the embodiment of the present application is that: according to the embodiment of the present application, the problem of how the source UE and/or the destination UE trigger relay selection or reselection in the UE-to-UE relay scenario is solved, and wireless signal quality between the source UE or the destination UE and the relay UE may be guaranteed to meet the service quality requirements.

With reference to the specification and drawings below, a specific embodiment of the present application is disclosed in detail, which specifies the manner in which the principle of the present application is adopted. It should be understood that, the scope of the embodiment of the present application is not limited. Within the scope of the spirit and clause of the appended claims, the embodiment of the present application includes many variations, modifications and equivalents.

The features described and/or shown for one embodiment may be used in one or more other embodiments in the same or similar manner, may be combined with the features in other embodiments or replace the features in other embodiments.

It should be emphasized that, the term “include/contain/comprise” refers to, when being used in the text, existence of features, parts, steps or assemblies, without exclusion of existence or attachment of one or more other features, parts, steps or assemblies.

### BRIEF DESCRIPTION OF THE DRAWINGS

Elements and features described in one of the drawings or embodiments of the present application may be combined with the elements and features shown in one or more other drawings or embodiments. Moreover, in the drawings, similar reference signs indicate corresponding parts in several drawings and may be used to indicate corresponding parts used in more than one embodiment.

The included drawings are used for providing further understanding on the embodiment of the present application, constitute a portion of the Description, are used for illustrating the embodiment of the present application and explain the principle of the present application together with the literary description. Obviously, the drawings described below are merely some examples of the present application, persons ordinarily skilled in the art can also obtain other drawings according to these drawings without making creative efforts. In the drawings:

FIG. 1 is a schematic diagram of a UE-to-UE relay scenario;

FIG. 2 is a schematic diagram of a network architecture of the scenario shown in FIG. 1;

FIG. 3 is a schematic diagram of a UE-to-Network relay scenario;

FIG. 4 is a schematic diagram of a relay selection or reselection method in the embodiment of the present application;

FIG. 5 is another schematic diagram of a relay selection or reselection method in the embodiment of the present application;

FIG. 6 is a further schematic diagram of a relay selection or reselection method in the embodiment of the present application;

FIG. 7 is a schematic diagram of a relay selection or reselection apparatus in the embodiment of the present application;

FIG. 8 is another schematic diagram of a relay selection or reselection apparatus in the embodiment of the present application;

FIG. 9 is a further schematic diagram of a relay selection or reselection apparatus in the embodiment of the present application;

FIG. 10 is a schematic diagram of a communication system in the embodiment of the present application;

FIG. 11 is a schematic diagram of a terminal equipment in the embodiment of the present application;

FIG. 12 is a schematic diagram of a relay device in the embodiment of the present application.

### DETAILED DESCRIPTION

With reference to the drawings, the foregoing and other features of the present application will become apparent through the following description. The Description and drawings specifically disclose the particular embodiment of the present application, showing part of the embodiment in which the principle of the present application may be adopted, it should be understood that the present application is not limited to the described embodiment, on the contrary, the present application includes all modifications, variations and equivalents that fall within the scope of the appended claims.

In embodiments of the present application, the terms “first”, “second”, etc., are used to distinguish different elements by their appellation, but do not indicate the spatial arrangement or chronological order of these elements, etc., and these elements shall not be limited by the terms. The term “and/or” includes any and all combinations of one or more of the terms listed in association with the term. The terms “contain”, “include”, “have”, etc., refer to the presence of the stated feature, element, component or assembly, but do not exclude the presence or addition of one or more other features, elements, components or assemblies.

In the embodiment of the present application, the singular forms “a/an”, “the”, etc., including the plural forms, shall be broadly understood as “a sort of” or “a kind of” and not limited to the meaning of “one”; furthermore, the term “said” shall be understood to include both the singular form and the plural form, unless it is expressly indicated otherwise in the context. In addition, the term “according to” should be understood to mean “at least partially according to . . . ”, and the term “based on” should be understood to mean “based at least partially on . . . ”, unless it is expressly indicated otherwise in the context.

In embodiments of the present application, the term “communications network” or “wireless communications network” may refer to a network that complies with any of the following communication standards, such as Long Term Evolution (LTE), Enhanced Long Term Evolution (LTE-A), Wideband Code Division Multiple Access (WCDMA), High-Speed Packet Access (HSPA), etc.

In addition, the communication between the devices in the communication system may be carried out according to the communication protocol of any stage, for example, including but not being limited to 1G (generation), 2G, 2.5G, 2.75G, 3G, 4G, 4.5G and future 5G, New Radio (NR), etc., and/or other communication protocols currently known or to be developed in the future.

In the embodiment of the present application, the term “network device” refers to, for example, a device in the communication system that connects a terminal device to the communication network and provides services to the terminal device. The network device may include but is not limited to: a base station (BS), an access point (AP), a transmission reception point (TRP), a broadcast transmitter, a mobile management entity (MME), a gateway, a server, a radio network controller (RNC), a base station controller (BSC), etc.

The base station may include, but is not limited to, a node B (NodeB or NB), an evolution node B (eNodeB or eNB), 5G base station (gNB), etc., and may also include a remote radio head (RRH), a remote radio unit (RRU), a relay, or a low-power node (such as femto, pico, etc.). And the term “base station” may include some or all of their functions, with each base station providing communication coverage to a specific geographic area. The term “cell” can refer to a base station and/or its coverage area, depending on the context in which the term is used.

In the embodiment of the present application, the term “user equipment” (UE) refers, for example, to a device that is connected to the communication network through the network device and receives network services, and may also be referred to as “Terminal Equipment” (TE). The terminal device may be fixed or movable, and may also be called a mobile station (MS), a terminal, a user, a subscriber station (SS), an access terminal (AT), a station, etc.

The terminal device may include but is not limited to: a cellular phone, a personal digital assistant (PDA), a wireless modem, a wireless communication device, a handheld device, a machine-type communication device, a laptop computer, a cordless phone, a smart phone, a smart watch, a digital camera, etc.

For another example, in scenarios such as Internet of Things (IoT), the terminal device may also be a machine or an apparatus that performs monitoring or measurement, and may include, but is not limited to, a machine type communication (MTC) terminal, a vehicle communication terminal, a device to device (D2D) terminal, a machine to machine (M2M) terminal, and etc.

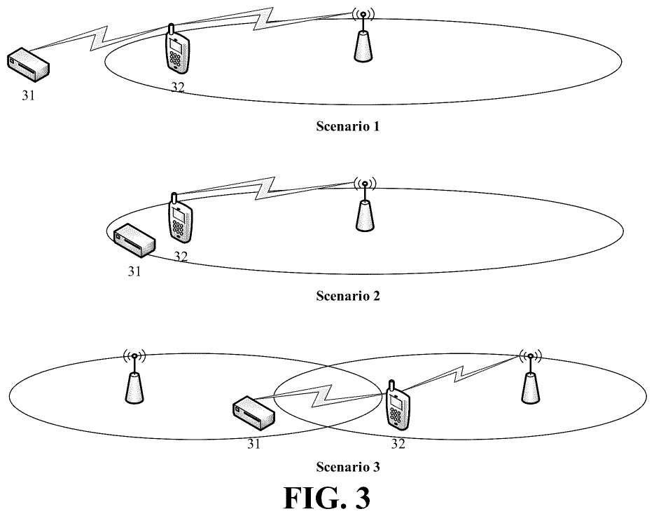

FIG. 3 is a schematic diagram of a UE-to-Network relay scenario. As shown in FIG. 3, in a scenario 1, a remote UE 31 is outside the coverage of the network, and a relay UE 32 is in the coverage of the network; in a scenario 2, both the remote UE 31 and the relay UE 32 are in the coverage of the network; and in a scenario 3, the remote UE 31 and the relay UE 32 are in different cell coverage ranges.

In UE-to-Network relay in Release 17, the remote UE triggers relay selection in the following situations:
a direct Uu signal strength of a current service cell being lower than the configured signal strength threshold;
an upper layer (a ProSe layer) indication;

In UE-to-Network relay in Release 17, the remote UE triggers relay reselection in the following situations:
a PC5 signal strength of a current relay UE being lower than the (pre)configured signal strength threshold;
the relay UE indicating cell selection/re-selection, switching, or Uu interface radio link failure (RLF) via PC5-RRC connection;
when the remote UE receives a PC5-S link release message from the relay UE;
when the remote UE detects the RLF of the PC5 interface;
an upper layer (a ProSe layer) indication;

The related art only specifies a case in which a remote UE triggers relay selection or reselection in a UE-to-Network relay scenario. In the UE-to-UE relay scenario, the signal strength of the Uu interface or communication with the network is not involved. Therefore, some cases of triggering relay selection or reselection in the related art are not applicable to the triggering of relay selection or reselection by a source UE and/or a destination UE in the UE-to-UE relay scenario.

The present application is proposed in view of the above problems. The various embodiments of the present application are illustrated below with reference to the accompanying drawings. These embodiments are exemplary only and are not limitations to the present application.

### An Embodiment of First Aspect

The embodiment of the present application provides a relay selection or reselection method, which is described from a side of a first terminal equipment.

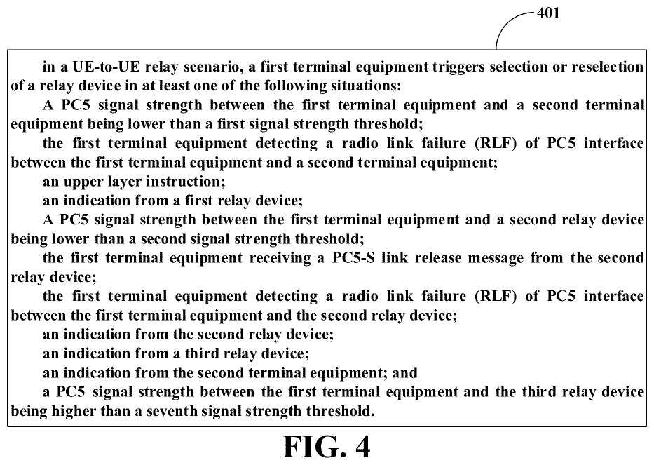

FIG. 4 is a schematic diagram of a relay selection or reselection method in the embodiment of the present application, referring to FIG. 4, the method includes:
401: in a UE-to-UE relay scenario, a first terminal equipment triggers selection or reselection of a relay device in at least one of the following situations:
a PC5 signal strength between the first terminal equipment and a second terminal equipment being lower than a first signal strength threshold;
the first terminal equipment detecting a radio link failure (RLF) of PC5 interface between the first terminal equipment and a second terminal equipment;
an upper layer indication;
an indication from a first relay device;
a PC5 signal strength between the first terminal equipment and a second relay device being lower than a second signal strength threshold;
the first terminal equipment receiving a PC5-S link release message from the second relay device;
the first terminal equipment detecting a radio link failure (RLF) of PC5 interface between the first terminal equipment and the second relay device;
an indication from the second relay device;
an indication from a third relay device;
an indication from the second terminal equipment; and
a PC5 signal strength between the first terminal equipment and the third relay device being higher than a seventh signal strength threshold.

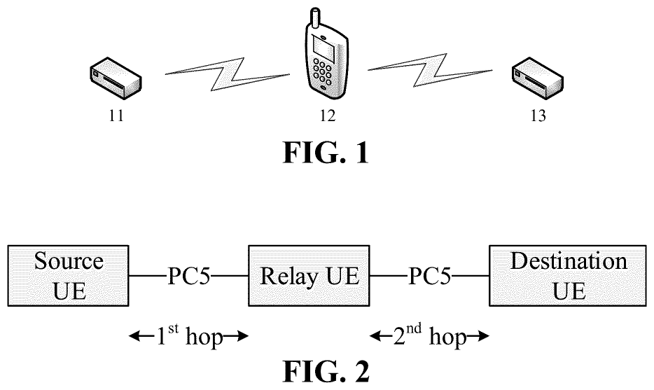

In the embodiment of the present application, the first terminal equipment may be the source UE in the UE-to-UE relay scenario, such as a first remote UE or the source UE 11 in the scene shown in FIG. 1, or the destination UE in the UE-to-UE relay scenario, such as a second remote UE or the destination UE 13 in the scenario shown in FIG. 1. Correspondingly, if the first terminal equipment is the source UE in the UE-to-UE relay scenario, then the second terminal equipment is the destination UE in the UE-to-UE relay scenario; if the first terminal equipment is the destination UE in the UE-to-UE relay scenario, the second terminal equipment is the source UE in the UE-to-UE relay scenario.

According to the embodiment of the present application, the triggering conditions for relay selection or reselection by the source UE and/or the destination UE in the UE-to-UE relay scenario are specified, and the problem of how to trigger relay selection or re-selection by the source UE and/or the destination UE in the UE-to-UE relay scenario is solved.

In some embodiments, in a UE-to-UE relay scenario, a first terminal equipment triggers selection of a relay device in at least one of the following situations:
a PC5 signal strength between the first terminal equipment and a second terminal equipment being lower than a first signal strength threshold;
the first terminal equipment detecting a radio link failure (RLF) of PC5 interface between the first terminal equipment and a second terminal equipment;
an upper layer indication;
an indication from a first relay device.

In the above embodiments, in one case, the selection of the relay device is triggered when the first terminal equipment detects that the PC5 signal strength between the first terminal equipment and the second terminal equipment is lower than a first signal strength threshold. The first signal strength threshold may be preconfigured, or configured by a network device, or predefined, which is not limited in the present application. In addition, the PC5 signal strength between the first terminal equipment and the second terminal equipment, i.e., the PC5 signal strength between the first terminal equipment and the second terminal equipment, may be SL-RSRP (a side link reference signal receiving power) and/or SD-RSRP (a side link discovery message reference signal receiving power), etc. of the second terminal equipment on the PC5 interface that are measured by the first terminal equipment.

In the above embodiments, in one case, the selection of the relay device is triggered when the first terminal equipment detects that a radio link failure (RLF) has occurred at the PC5 interface between the first terminal equipment and the second terminal equipment. For example, the second terminal equipment has one or more destinations or destination IDs or L2 IDs, and when a side link RLC entity of the first terminal equipment indicates that the maximum number of times of retransmission to the destination of the second terminal equipment is reached, it is regarded that RLF occurs at the PC5 interface between the first terminal equipment and the second terminal equipment; or when a T400 timer in the first terminal equipment for the destination of the second terminal equipment expires, it is regarded that RLF occurs at the PC5 interface between the first terminal equipment and the second terminal equipment; or when the MAC (media access control) entity of the first terminal equipment indicates that the maximum number of consecutive HARQ DTXs (non-consecutive transmission) to the destination of the second terminal equipment is reached, it is regarded that RLF occurs at the PC5 interface between the first terminal equipment and the second terminal equipment; or when a side link PDCP (Packet Data Convergence Protocol) entity of the first terminal equipment indicates that integrality checking for SL-SRB2 or SL-SRB3 of the destination of the second terminal equipment fails, it is regarded that RLF occurs at the PC5 interface between the first terminal equipment and the second terminal equipment.

In the above embodiments, in one case, the selection of the relay device is triggered when the first terminal equipment receives an indication from the upper layer. Here, the upper layer refers to a layer above the RRC (Radio Resource Control) or PDCP or MAC of the first terminal equipment, and for example, it may be a non-access stratum (NAS), or a V2X layer (a vehicle to everything layer, which may provide related functions of communication between vehicle and others), or a ProSe layer (a Proximity-based Services layer, which may provide related functions of services between adjacent terminal equipments), etc.

In the above embodiments, in one case, the selection of the relay device is triggered when the first terminal equipment receives an indication from the first relay device. Here, the first relay device is a candidate relay device. For example, the relay device may have the capability of relaying services from the source UE to the destination UE. Here, the indication from the first relay device includes, for example:
a PC5 signal strength between the first relay device and the first terminal equipment is higher than a third signal strength threshold, and/or, a PC5 signal strength between the first relay device and the second terminal equipment is higher than a fourth signal strength threshold. That is, when the PC5 signal strength between the first relay device and the first terminal equipment is higher than the third signal strength threshold, or the PC5 signal strength between the first relay device and the second terminal equipment is higher than the fourth signal strength threshold, the first relay device transmits an indication to the first terminal equipment, and the first terminal equipment triggers the selection of the relay device after receiving the indication from the first relay device. The PC5 signal strength may be SL-RSRP and/or SD-RSRP, etc. of the first terminal equipment or the second terminal equipment on the PC5 interface measured by the first relay device. The third signal strength threshold and the fourth signal strength threshold may be preconfigured, or configured by a network device, or predefined, which is not limited in the present application.

In the above embodiments, the indications from the first relay device may be transmitted via discovery related messages or PC5 direct communication related messages or PC5-RRC messages, but which is not limited in the present application. The PC5-RRC message is a message after PC5 connection is established between the first terminal equipment and the first relay device.

In some other embodiments, in a UE-to-UE relay scenario, a first terminal equipment triggers reselection of a relay device in at least one of the following situations:
a PC5 signal strength between the first terminal equipment and a second relay device being lower than a second signal strength threshold;
the first terminal equipment receiving a PC5-S link release message from the second relay device;
the first terminal equipment detecting a radio link failure (RLF) of PC5 interface between the first terminal equipment and the second relay device;
an upper layer indication;
an indication from the second relay device;
an indication from a third relay device;
an indication from the second terminal equipment; and
a PC5 signal strength between the first terminal equipment and the third relay device being higher than a seventh signal strength threshold.

In the above embodiments, in one case, the reselection of the relay device is triggered when the first terminal equipment detects that the PC5 signal strength between the first terminal equipment and the second relay device is lower than a second signal strength threshold. Here, the second relay device is the current relay device through which the first terminal equipment communicates with the second terminal equipment. The second signal strength threshold may be preconfigured, or configured by a network device, or predefined, which is not limited in the present application. In addition, the PC5 signal strength between the first terminal equipment and the second relay device, i.e., the signal strength of PC5 interface between the first terminal equipment and the second relay device, may be SL-RSRP and/or SD-RSRP, etc. of the second relay device on the PC5 interface that are measured by the first terminal equipment.

In the above embodiments, in one case, the reselection of the relay device is triggered when the first terminal equipment receives a PC5-S (PC5-Signalling) link release message from the second relay device. For example, when the second relay device releases the PC5-S link between the second relay device and the first terminal equipment, it may transmit the above PC5-S link release message (such as a Disconnect Request message) to the first terminal equipment, and the first terminal equipment triggers the reselection of the relay device after receiving the message, or the first terminal equipment may trigger the reselection of the relay device when transmitting a link release response message, such as a Disconnect Response message.

In the above embodiments, in one case, the reselection of the relay device is triggered when the first terminal equipment detects that a radio link failure (RLF) has occurred at the PC5 interface between the first terminal equipment and the second relay device. For example, the second relay device has one or more destinations or destination IDs or L2 IDs, and when a side link RLC entity of the first terminal equipment indicates that the maximum number of times of retransmission to the destination of the second relay device is reached, it is regarded that RLF occurs at the PC5 interface between the first terminal equipment and the second relay device; or when a T400 timer in the first terminal equipment for the destination of the second relay device expires, it is regarded that RLF occurs at the PC5 interface between the first terminal equipment and the second relay device; or when the MAC (media access control) entity of the first terminal equipment indicates that the maximum number of consecutive HARQ DTXs (non-consecutive transmission) to the destination of the second relay device is reached, it is regarded that RLF occurs at the PC5 interface between the first terminal equipment and the second relay device; or when a side link PDCP entity of the first terminal equipment indicates that integrality checking for SL-SRB2 or SL-SRB3 of the destination of the second relay device fails, it is regarded that RLF occurs at the PC5 interface between the first terminal equipment and the second relay device.

In the above embodiments, in one case, the reselection of the relay device is triggered when the first terminal equipment receives an indication from the upper layer. Here, the upper layer refers to a layer above the RRC or PDCP or MAC of the first terminal equipment, and for example, it may be a non-access stratum, or a V2X layer, or a ProSe layer, etc.

In the above embodiments, in one case, the reselection of the relay device is triggered when the first terminal equipment receives an indication from the second relay device. Here, the indication from the second relay device includes, for example, at least one of the following:
the second relay device detecting an RLF of PC5 interface or PC5-RRC connection between the second relay device and the second terminal equipment;
a PC5 signal strength between the second relay device and the second terminal equipment being lower than a fifth signal strength threshold;
the second terminal equipment performing or being about to perform relay device reselection;
a PC5-S link between the second relay device and the second terminal equipment being released; and
a PC5 signal strength between a third relay device and the second terminal equipment being higher than a sixth signal strength threshold.

In the above embodiments, in one case, when the second relay device detects that RLF has occurred at the PC5 interface or PC5-RRC connection between the second relay device and the second terminal equipment, it transmits an indication to the first terminal equipment, and the first terminal equipment triggers the reselection of the relay device upon receiving the indication. For example, the second terminal equipment has one or more destinations or destination IDs or L2 IDs, and when a side link RLC entity of the second relay device indicates that the maximum number of times of retransmission to the destination of the second terminal equipment is reached, it is regarded that RLF occurs at the PC5 interface or PC5-RRC connection between the second relay device and the second terminal equipment; or when a T400 timer of the second relay device for the destination of the second terminal equipment expires, it is regarded that RLF occurs at the PC5 interface or PC5-RRC connection between the second relay device and the second terminal equipment; or when the MAC (media access control) entity of the second relay device indicates that the maximum number of consecutive HARQ DTXs (non-consecutive transmission) to the destination of the second terminal equipment is reached, it is regarded that RLF occurs at the PC5 interface or PC5-RRC connection between the second relay device and the second terminal equipment; or when a side link PDCP (Packet Data Convergence Protocol) entity of the second relay device indicates that integrality checking for SL-SRB2 or SL-SRB3 of the destination of the second terminal equipment fails, it is regarded that RLF occurs at the PC5 interface or PC5-RRC connection between the second relay device and the second terminal equipment.

In the above embodiments, in one case, when the second relay device detects that the PC5 signal strength between the second relay device and the second terminal equipment is lower than a fifth signal strength threshold, it transmits an indication to the first terminal equipment, and the first terminal equipment triggers the reselection of the relay device upon receiving the indication. The fifth signal strength threshold may be preconfigured, or configured by a network device, or predefined, which is not limited in the present application. In addition, the PC5 signal strength between the second relay device and the second terminal equipment, i.e., the signal strength of PC5 interface between the second relay device and the second terminal equipment, may be SL-RSRP and/or SD-RSRP, etc. of the second terminal equipment on the PC5 interface that are measured by the second relay device.

In the above embodiments, in one case, when the second terminal equipment performs or is about to perform reselection of the relay device, such case may be notified to the second relay device via a PC5-RRC message or PC5-S signaling. After receiving the notification from the second terminal equipment, the second relay device transmits an indication to the first terminal equipment, and the first terminal equipment triggers the reselection of the relay device after receiving the indication.

In the above embodiments, in one case, when the second relay device releases the PC5-S link between the second relay device and the second terminal equipment, it transmits an indication to the first terminal equipment, and the first terminal equipment triggers the reselection of the relay device after receiving the indication. For example, the second relay device transmits a PC5-S link release message (such as a Disconnect Request message) to the second terminal equipment, and transmits the above indication to the first terminal equipment, or the second relay device transmits the above indication to the first terminal equipment when or after receiving a link release response message (such as a Disconnect Response message) from the second terminal equipment.

In the above embodiments, in one case, when the third relay device detects that the PC5 signal strength between the third relay device and the second terminal equipment is higher than a sixth signal strength threshold, it may notify such case to the second relay device, and the second relay device transmits an indication to the first terminal equipment after receiving the notification from the third relay device, and the first terminal equipment triggers the reselection of the relay device after receiving the indication. The sixth signal strength threshold may be preconfigured, or configured by a network device, or predefined, which is not limited in the present application. In addition, the PC5 signal strength between the third relay device and the second terminal equipment, i.e., the signal strength of PC5 interface between the third relay device and the second terminal equipment, may be SL-RSRP and/or SD-RSRP, etc. of the second terminal equipment on the PC5 interface that are measured by the third relay device.

In the above embodiments, the third relay device may also report the above situation to the first terminal equipment by other means. For example, the third relay device informs the second terminal equipment of the above situation, and then the second terminal equipment indicates it to the first terminal equipment, and so on.

In the above embodiments, the indication from the second relay device may be transmitted via at least one of a PC5-RRC message, PC5-S signaling, a side link MAC CE (media access control control element) and an SRAP (sidelink relay adaptation layer) control PDU (Protocol Data Unit), which is not limited in the present application.

In the above embodiments, in one case, the reselection of the relay device is triggered when the first terminal equipment receives an indication from the third relay device. The third relay device is another relay device than a current relay device via which the first terminal equipment communicates with the second terminal equipment. Here, the indication from the third relay device includes, for example:
a PC5 signal strength between the third relay device and the first terminal equipment being higher than a seventh signal strength threshold, and/or a PC5 signal strength between the third relay device and the second terminal equipment being higher than a sixth signal strength threshold. That is, when the PC5 signal strength between the third relay device and the first terminal equipment is higher than the seventh signal strength threshold, or the PC5 signal strength between the third relay device and the second terminal equipment is higher than the sixth signal strength threshold, the third relay device transmits an indication to the first terminal equipment, and the first terminal equipment triggers the selection of the relay device after receiving the indication from the third relay device. The sixth signal strength threshold and the seventh signal strength threshold may be preconfigured, or configured by a network device, or predefined, which is not limited in the present application. In addition, the PC5 signal strength between the third relay device and the first terminal equipment, i.e., the signal strength of PC5 interface between the third relay device and the first terminal equipment, may be SL-RSRP and/or SD-RSRP, etc. of the first terminal equipment on the PC5 interface that are measured by the third relay device.

In the above embodiments, the indication from the third relay device may be transmitted via discovery related messages or PC5 direct communication related messages or PC5-RRC messages, but which is not limited in the present application. The PC5-RRC message is a message after PC5 connection is established between the first terminal equipment and the third relay device.

In the above embodiments, in one case, the reselection of the relay device is triggered when the first terminal equipment receives an indication from the second terminal equipment. Here, the indication from the second terminal equipment includes, for example, at least one of the following:
end-to-end PC5-RRC connection or a PC5 link between the first terminal equipment and the second terminal equipment being released;
the second terminal equipment performing or being about to perform relay device selection or reselection; and
a PC5 signal strength between a third relay device and the second terminal equipment being higher than a sixth signal strength threshold.

In the above embodiments, in one case, after the end-to-end PC5-RRC connection or the PC5 link between the first terminal equipment and the second terminal equipment is released, the second terminal equipment transmits an indication to the first terminal equipment, and the first terminal equipment triggers the reselection of the relay device upon receiving the indication.

In the above embodiments, in one case, when the second terminal equipment performs or is about to perform selection or reselection of the relay device, it may transmit an indication to the first terminal equipment to indicate such a case to the first terminal equipment, and the first terminal equipment triggers the reselection of the relay device upon receiving the indication.

In the above embodiments, in one case, when the second terminal equipment detects that the PC5 signal strength between the second terminal equipment and the third relay device is higher than the configured sixth signal strength threshold, the second terminal equipment may transmit an indication to the first terminal equipment to indicate such a case to the first terminal equipment, and the first terminal equipment triggers the reselection of the relay device upon receiving the indication. The PC5 signal strength between the second terminal equipment and the third relay device, i.e., the signal strength of PC5 interface between the second terminal equipment and the third relay device, may be SL-RSRP and/or SD-RSRP, etc. of the third relay device on the PC5 interface that are measured by the second terminal equipment.

In the above embodiments, the indication from the second terminal equipment may be transmitted via an end-to-end PC5-RRC message or PC5-S signaling, which is not limited in the present application.

In the above embodiments, in one case, the reselection of the relay device is triggered when the first terminal equipment detects that the PC5 signal strength between the first terminal equipment and the third relay device is lower than the seventh signal strength threshold. The PC5 signal strength between the first terminal equipment and the third relay device, i.e., the signal strength of PC5 interface between the first terminal equipment and the third relay device, may be SL-RSRP and/or SD-RSRP, etc. of the third relay device on the PC5 interface that are measured by the first terminal equipment.

In the preceding embodiments, the first terminal equipment triggers the reselection of the relay device, that is, it does not take the second relay device as the relay device via which it communicates with the second terminal equipment.

In each of the above embodiments, after triggering the selection or reselection of the relay device, the first terminal equipment and/or the second terminal equipment may use the standard of the upper layer to perform the selection or reselection of the relay device. During the selection or reselection of the relay device, when the first terminal equipment and/or the second terminal equipment detect(s) that the PC5 signal strength between it (they) and a relay device is higher than an eighth signal strength threshold, the relay device is considered to be suitable. The eighth signal strength threshold may be preconfigured or configured by network. The first terminal equipment and/or the second terminal equipment searches for a suitable relay device that meets the access stratum standard and/or the upper layer standard. If there are multiple suitable relay devices that meet the access layer standard and the upper layer standard, one of which is selected via implementation of the first terminal equipment and/or the second terminal equipment.

The embodiments above only schematically illustrate the triggering conditions of the embodiment of the present application, but the present application is not limited to this, and appropriate variations may also be made on the basis of the above embodiments. For example, the triggering conditions of the above embodiments may be used separately, or one or more of the triggering conditions of the above embodiments may be combined.

In the embodiments of the present application, in some implementations, the first terminal equipment may notify the second terminal equipment of the case triggering of selection of the relay device, or notify the current relay device (the second relay device) and/or the second terminal equipment of the case triggering of reselection of the relay device, so that the current relay device/second terminal equipment knows that the first terminal equipment triggers the selection/reselection of the relay device.

In the embodiments of the present application, in some implementations, the first terminal equipment may establish connection with the second terminal equipment via the selected or re-selected relay device. The method and process of establishing the connection is not limited in the present application.

In the embodiments of the present application, the value of each signal strength threshold is not limited, and different signal strength thresholds may be the same or different.

According to the method in the embodiment of the present application, the triggering conditions for relay selection or reselection by the source UE and/or the destination UE in the UE-to-UE relay scenario are specified, and the problem of how to trigger relay selection or re-selection by the source UE and/or the destination UE in the UE-to-UE relay scenario is solved.

### An Embodiment of Second Aspect

The embodiment of the present application provides a relay selection or reselection method, and is described from a side of a relay device, and the same content as the embodiment of the first aspect will not be repeated.

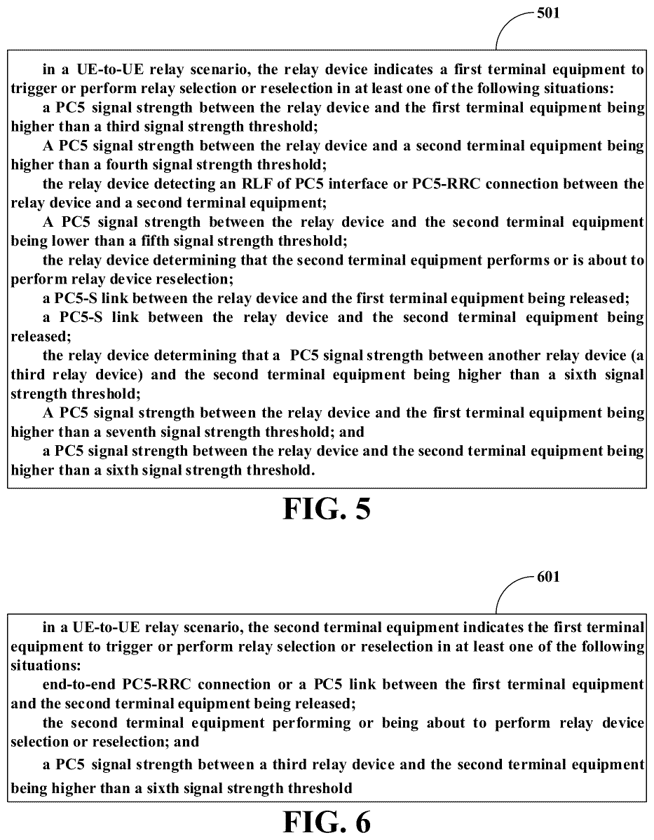

FIG. 5 is a schematic diagram of a relay selection or reselection method in the embodiment of the present application, as shown in FIG. 5, the method includes:
501: in a UE-to-UE relay scenario, the relay device indicates a first terminal equipment to trigger or perform relay selection or reselection in at least one of the following situations:
a PC5 signal strength between the relay device and the first terminal equipment being higher than a third signal strength threshold, the relay device being a candidate relay device (a first relay device);
a PC5 signal strength between the relay device and a second terminal equipment being higher than a fourth signal strength threshold, the relay device being a candidate relay device (the first relay device);
the relay device detecting an RLF of PC5 interface or PC5-RRC connection between the relay device and a second terminal equipment, the relay device being a current relay device (a second relay device) via which the first terminal equipment communicates with the second terminal equipment;
a PC5 signal strength between the relay device and the second terminal equipment being lower than a fifth signal strength threshold, the relay device being a current relay device (the second relay device) via which the first terminal equipment communicates with the second terminal equipment;
the relay device determining that the second terminal equipment performs or is about to perform relay device reselection, the relay device being a current relay device (the second relay device) via which the first terminal equipment communicates with the second terminal equipment;
a PC5-S link between the relay device and the first terminal equipment being released, the relay device being a current relay device (the second relay device) via which the first terminal equipment communicates with the second terminal equipment;
a PC5-S link between the relay device and the second terminal equipment being released, the relay device being a current relay device (the second relay device) via which the first terminal equipment communicates with the second terminal equipment;
the relay device determining that a PC5 signal strength between another relay device (a third relay device) and the second terminal equipment being higher than a sixth signal strength threshold, the relay device being a current relay device (the second relay device) via which the first terminal equipment communicates with the second terminal equipment;
a PC5 signal strength between the relay device and the first terminal equipment being higher than a seventh signal strength threshold, the relay device being another relay device (the third relay device) than a current relay device via which the first terminal equipment communicates with the second terminal equipment; and
a PC5 signal strength between the relay device and the second terminal equipment being higher than a sixth signal strength threshold, the relay device being another relay device (the third relay device) than a current relay device via which the first terminal equipment communicates with the second terminal equipment.

For example, if the PC5 signal strength between the relay device (the first relay device) and the first terminal equipment is higher than the third signal strength threshold, the relay device transmits an indication to the first terminal equipment, and the first terminal equipment triggers or performs selection of the relay device according to the indication.

For another example, if the PC5 signal strength between the relay device (the first relay device) and the second terminal equipment is higher than the fourth signal strength threshold, the relay device transmits an indication to the first terminal equipment, and the first terminal equipment triggers or performs selection of the relay device according to the indication.

For another example, if the relay device (the second relay device) detects the RLF of PC5 interface or PC5-RRC connection between the relay device (the second relay device) and the second terminal equipment, the relay device transmits an indication to the first terminal equipment, and the first terminal equipment triggers or performs reselection of the relay device according to the indication.

For another example, if the PC5 signal strength between the relay device (the second relay device) and the second terminal equipment is lower than the fifth signal strength threshold, the relay device transmits an indication to the first terminal equipment, and the first terminal equipment triggers or performs reselection of the relay device according to the indication.

For another example, if the relay device (the second relay device) determines that the second terminal equipment performs or is about to perform relay device reselection, the relay device transmits an indication to the first terminal equipment, and the first terminal equipment triggers or performs reselection of the relay device according to the indication.

For another example, if the PC5-S link between the relay device (the second relay device) and the first terminal equipment is released, the relay device transmits a PC5-S link release message (such as a Disconnect Request message) to the first terminal equipment, which indicates the first terminal equipment to trigger the reselection of the relay device. The first terminal equipment triggers the reselection of the relay device after receiving the message, or the first terminal equipment triggers the reselection of the relay device after replying a PC5-S link release response message (such as a Disconnect Response message).

For another example, if the PC5-S link between the relay device (the second relay device) and the second terminal equipment is released, the relay device transmits an indication to the first terminal equipment, and the first terminal equipment triggers or performs reselection of the relay device according to the indication.

For another example, if the relay device (the second relay device) determines that the PC5 signal strength between another relay device (the third relay device) and the second terminal equipment is higher than the sixth signal strength threshold, the relay device transmits an indication to the first terminal equipment, and the first terminal equipment triggers or performs reselection of the relay device according to the indication.

For another example, if the PC5 signal strength between the relay device (the third relay device) and the first terminal equipment is higher than the seventh signal strength threshold, the relay device transmits an indication to the first terminal equipment, and the first terminal equipment triggers or performs reselection of the relay device according to the indication.

For another example, if the PC5 signal strength between the relay device (the third relay device) and the second terminal equipment is higher than the sixth signal strength threshold, the relay device transmits an indication to the first terminal equipment, and the first terminal equipment triggers or performs reselection of the relay device according to the indication.

In some embodiments, the indication from the relay device is transmitted via at least one of a discovery-related message, a PC5 direct communication related message, a PC5-RRC message, PC5-S signaling, a sidelink MAC CE and an SRAP control PDU. Among them, different indications may be transmitted via the same or different messages/signaling, which has been described in the embodiment of the first aspect and is omitted here.

In some embodiments, the relay device can also receive information (referred to as first information) from the second terminal equipment, and determine that the second terminal equipment performs or is about to perform relay device reselection according to the first information.

In the above embodiments, the first information may be transmitted to the relay device by the second terminal equipment via a PC5-RRC message or PC5-S signaling, which is not limited in the present application.

In some embodiments, the relay device (the second relay device) may also receive information (referred to as second information) from another relay device (the third relay device) or from the second terminal equipment, and determine that the PC5 signal strength between the another relay device and the second terminal equipment is higher than the sixth signal strength threshold.

In the embodiments of the present application, the signal strength thresholds described above may be preconfigured, or configured by a network device, or predefined, which is not limited in the present application. In addition, the values of the signal strength thresholds may be the same or different.

The embodiments above only schematically illustrate the embodiment of the present application, but the present application is not limited to this, and appropriate variations may also be made on the basis of the above embodiments. For example, the above embodiments may be used separately, or one or more of the above embodiments may be combined.

According to the method in the embodiment of the present application, the triggering conditions for relay selection or reselection by the source UE and/or the destination UE in the UE-to-UE relay scenario are specified, and the problem of how to trigger relay selection or re-selection by the source UE and/or the destination UE in the UE-to-UE relay scenario is solved.

### An Embodiment of Third Aspect

The embodiment of the present application provides a relay selection or reselection method, and is described from a side of a second terminal equipment, and the same content as the embodiment of the first aspect will not be repeated.

FIG. 6 is a schematic diagram of a relay selection or reselection method in the embodiment of the present application, as shown in FIG. 6, the method includes:
601: in a UE-to-UE relay scenario, the second terminal equipment indicates the first terminal equipment to trigger or perform relay selection or reselection in at least one of the following situations:
end-to-end PC5-RRC connection or a PC5 link between the first terminal equipment and the second terminal equipment being released;
the second terminal equipment performing or being about to perform relay device selection or reselection; and
a PC5 signal strength between a third relay device and the second terminal equipment being higher than a sixth signal strength threshold;
wherein the third relay device is another relay device than a current relay device via which the first terminal equipment communicates with the second terminal equipment.

For example, if the end-to-end PC5-RRC connection or the PC5 link between the first terminal equipment and the second terminal equipment is released, the second terminal equipment transmits an indication to the first terminal equipment, and the first terminal equipment triggers or performs reselection of the relay device according to the indication.

For another example, if the second terminal equipment performs or is about to perform selection or reselection of the relay device, the second terminal equipment transmits an indication to the first terminal equipment, and the first terminal equipment triggers or performs reselection of the relay device according to the indication.

For another example, if the PC5 signal strength between the third relay device and the second terminal equipment is higher than the sixth signal strength threshold, the second terminal equipment transmits an indication to the first terminal equipment, and the first terminal equipment triggers or performs reselection of the relay device according to the indication.

In some embodiments, the sixth signal strength threshold is preconfigured, or is configured by a network device, or is predefined.

In some embodiments, the indication from the second terminal equipment may be transmitted via a PC5-RRC message or PC5-S signaling.

In some embodiments, the second terminal equipment may also receive information (referred to the third information) transmitted by the first terminal equipment, the third information indicating that the first terminal equipment has triggered selection or reselection of the relay device.

In some embodiments, the second terminal equipment may also establish a connection with the first terminal equipment via the selected or re-selected relay device, and the method and process of establishing the connection is not limited in the present application.

The embodiments above only schematically illustrate the embodiment of the present application, but the present application is not limited to this, and appropriate variations may also be made on the basis of the above embodiments. For example, the above embodiments may be used separately, or one or more of the above embodiments may be combined.

According to the method in the embodiment of the present application, the triggering conditions for relay selection or reselection by the source UE and/or the destination UE in the UE-to-UE relay scenario are specified, and the problem of how to trigger relay selection or re-selection by the source UE and/or the destination UE in the UE-to-UE relay scenario is solved.

### An Embodiment of Fourth Aspect

The embodiment of the present application provides a relay selection or reselection apparatus.

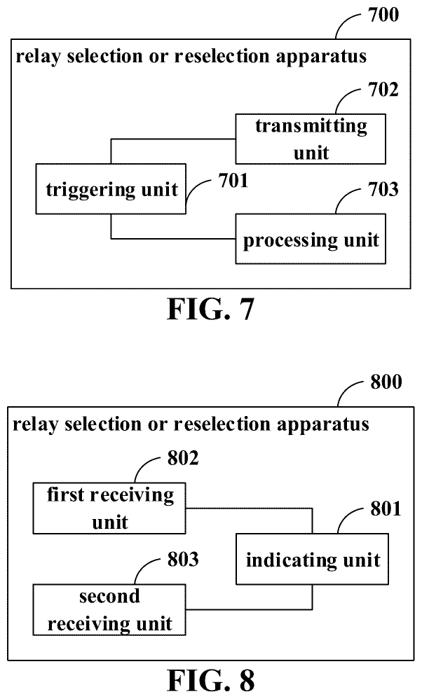

FIG. 7 is a schematic diagram of a relay selection or reselection apparatus in the embodiment of the present application. The apparatus may be, for example, a terminal equipment, or one or more parts or components configured in the terminal equipment, and for convenience, the terminal equipment is called the first terminal equipment. Since the principle for the apparatus to solve the problem is the same as the method of the embodiment of the first aspect, the implementation of the method of the embodiment of the first aspect may be referred to for the specific implementation of the apparatus, and the same contents will not be repeated.

As shown in FIG. 7, a relay selection or reselection apparatus 700 in the embodiment of the present application includes:
a triggering unit 701 configured to, in a UE-to-UE relay scenario, trigger selection or reselection of a relay device in at least one of the following situations:
a PC5 signal strength between the first terminal equipment and a second terminal equipment being lower than a first signal strength threshold;
the first terminal equipment detecting a radio link failure (RLF) of PC5 interface between the first terminal equipment and a second terminal equipment;
an upper layer indication;
an indication from a first relay device;
a PC5 signal strength between the first terminal equipment and a second relay device being lower than a second signal strength threshold;
the first terminal equipment receiving a PC5-S link release message from the second relay device;
the first terminal equipment detecting a radio link failure (RLF) of PC5 interface between the first terminal equipment and the second relay device;
an indication from the second relay device;
an indication from a third relay device;
an indication from the second terminal equipment; and
a PC5 signal strength between the first terminal equipment and the third relay device being higher than a seventh signal strength threshold;
wherein, the first relay device is a candidate relay device, the second relay device is a current relay device via which the first terminal equipment communicates with the second terminal equipment, and the third relay device is another relay device than the current relay device via which the first terminal equipment communicates with the second terminal equipment.

In some embodiments, the indication from the first relay device includes:
a PC5 signal strength between the first relay device and the first terminal equipment being higher than a third signal strength threshold, and/or, a PC5 signal strength between the first relay device and the second terminal equipment being higher than a fourth signal strength threshold.

In above embodiments, the indication from the first relay device may be transmitted via a discovery related message or a PC5-RRC message.

In some embodiments, the indication from the second relay device includes at least one of the following:
the second relay device detecting an RLF of PC5 interface or PC5-RRC connection between the second relay device and the second terminal equipment;
a PC5 signal strength between the second relay device and the second terminal equipment being lower than a fifth signal strength threshold;
the second terminal equipment performing or being about to perform relay device reselection;
a PC5-S link between the second relay device and the second terminal equipment being released; and
a PC5 signal strength between the third relay device and the second terminal equipment being higher than a sixth signal strength threshold.

In the above embodiments, the indication from the second relay device may be transmitted via at least one of a PC5-RRC message, PC5-S signaling, a sidelink MAC CE, and an SRAP control PDU.

In some embodiments, the indication from the third relay device includes:
a PC5 signal strength between the third relay device and the first terminal equipment being higher than the seventh signal strength threshold, and/or a PC5 signal strength between the third relay device and the second terminal equipment being higher than the sixth signal strength threshold.

In the above embodiments, the indication from the third relay device may be transmitted via a discovery related message or a PC5-RRC message.

In some embodiments, the indication from the second terminal equipment includes at least one of the following:
end-to-end PC5-RRC connection or a PC5 link between the first terminal equipment and the second terminal equipment being released;
the second terminal equipment performing or being about to perform relay device selection or reselection; and
a PC5 signal strength between the third relay device and the second terminal equipment being higher than the sixth signal strength threshold.

In the above embodiments, the indication from the second terminal equipment may be transmitted via an end-to-end PC5-RRC message or PC5-S signaling.

In some embodiments, as shown in FIG. 7, the apparatus 700 further includes:
a transmitting unit 702 configured to notify the second terminal equipment of a situation where selection of the relay device is triggered, or notify the current relay device and/or the second terminal equipment of a situation where reselection of the relay device is triggered.

In some embodiments, as shown in FIG. 7, the apparatus 700 further includes:
a processing unit 703 configured to establish connection with the second terminal equipment via the selected or reselected relay device.

In some embodiments, the signal strength thresholds are preconfigured, or are configured by a network device, or are predefined.

In some embodiments, the upper layer is a non-access stratum of the first terminal equipment.

FIG. 8 is another schematic diagram of a relay selection or reselection apparatus in the embodiment of the present application. The apparatus may be, for example, a relay device, or one or more parts or components configured in a relay device. Since the principle for the apparatus to solve the problem is the same as the method of the embodiment of the second aspect, the implementation of the method the embodiment of the second aspect may be referred to for the specific implementation of the apparatus, and the same contents will not be repeated.

As shown in FIG. 8, a relay selection or reselection apparatus 800 in the embodiment of the present application includes:
an indicating unit 801 configured to, in a UE-to-UE relay scenario, indicate a first terminal equipment to trigger or perform relay selection or reselection in at least one of the following situations:
a PC5 signal strength between the relay device and the first terminal equipment being higher than a third signal strength threshold, the relay device being a candidate relay device;
a PC5 signal strength between the relay device and a second terminal equipment being higher than a fourth signal strength threshold, the relay device being a candidate relay device;
the relay device detecting an RLF of PC5 interface or PC5-RRC connection between the relay device and the second terminal equipment, the relay device being a current relay device via which the first terminal equipment communicates with the second terminal equipment;
a PC5 signal strength between the relay device and the second terminal equipment being lower than a fifth signal strength threshold, the relay device being a current relay device via which the first terminal equipment communicates with the second terminal equipment;
the relay device determining that the second terminal equipment performs or is about to perform relay device reselection, the relay device being a current relay device via which the first terminal equipment communicates with the second terminal equipment;
a PC5-S link between the relay device and the first terminal equipment being released, the relay device being a current relay device via which the first terminal equipment communicates with the second terminal equipment;
a PC5-S link between the relay device and the second terminal equipment being released, the relay device being a current relay device via which the first terminal equipment communicates with the second terminal equipment;
the relay device determining that a PC5 signal strength between another relay device and the second terminal equipment being higher than a sixth signal strength threshold, the relay device being a current relay device via which the first terminal equipment communicates with the second terminal equipment;
a PC5 signal strength between the relay device and the first terminal equipment being higher than a seventh signal strength threshold, the relay device being another relay device than a current relay device via which the first terminal equipment communicates with the second terminal equipment; and
a PC5 signal strength between the relay device and the second terminal equipment being higher than a sixth signal strength threshold, the relay device being another relay device than a current relay device via which the first terminal equipment communicates with the second terminal equipment.

In some embodiments, the indication from the relay device is transmitted via at least one of a discovery-related message, a PC5-RRC message, PC5-S signaling, a sidelink MAC CE and an SRAP control PDU.

In some embodiments, as shown in FIG. 8, the apparatus 800 further includes:
a first receiving unit 802 configured to receive first information from the second terminal equipment, and determine that the second terminal equipment performs or is about to perform relay device reselection according to the first information.

In the above embodiments, the first information may be transmitted to the relay device by the second terminal equipment via a PC5-RRC message or PC5-S signaling.

In some embodiments, as shown in FIG. 8, the apparatus 800 further includes:
a second receiving unit 803 configured to receive second information from another relay device or from the second terminal equipment, and determine that a PC5 signal strength between the another relay device and the second terminal equipment is higher than the sixth signal strength threshold according to the second information.

In some embodiments, the signal strength thresholds are preconfigured, or are configured by a network device, or are predefined.

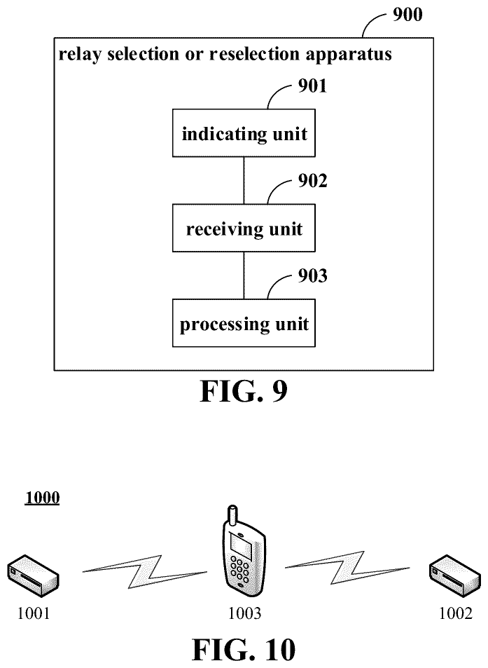

FIG. 9 is another schematic diagram of a relay selection or reselection apparatus in the embodiment of the present application. The apparatus may be, for example, a terminal equipment, or one or more parts or components configured in the terminal equipment, and for convenience, the terminal equipment is called the second terminal equipment. Since the principle for the apparatus to solve the problem is the same as the method of the embodiment of the third aspect, the implementation of the method the embodiment of the third aspect may be referred to for the specific implementation of the apparatus, and the same contents will not be repeated.

As shown in FIG. 9, a relay selection or reselection apparatus 900 in the embodiment of the present application includes:
an indicating unit 901 configured to, in a UE-to-UE relay scenario, indicate a first terminal equipment to trigger or perform relay selection or reselection in at least one of the following situations:
end-to-end PC5-RRC connection or a PC5 link between the first terminal equipment and the second terminal equipment being released;
the second terminal equipment performing or being about to perform relay device selection or reselection; and
a PC5 signal strength between a third relay device and the second terminal equipment being higher than a sixth signal strength threshold;
wherein the third relay device is another relay device than a current relay device via which the first terminal equipment communicates with the second terminal equipment.

In some embodiments, the sixth signal strength threshold is preconfigured, or is configured by a network device, or is predefined.

In some embodiments, the indication from the second terminal equipment is transmitted via a PC5-RRC message or PC5-S signaling.

In some embodiments, as shown in FIG. 9, the apparatus 900 further includes:
a receiving unit 902 configured to receive third information transmitted by the first terminal equipment, the third information indicating that the first terminal equipment has triggered relay device selection or reselection.

In some embodiments, as shown in FIG. 9, the apparatus 900 further includes:
a processing unit 903 configured to establish connection with the first terminal equipment via the selected or reselected relay device.

It is worth noting that only the components or modules related to the present application are illustrated hereinabove, but the present application is not limited to this. The relay selection or reselection apparatuses 700 to 900 of the embodiment of the present application may also include other components or modules, and the details of these components or modules may be seen by referring to the related art.

In addition, for the sake of simplicity, FIG. 7 through FIG. 9 only exemplarily shows the connection relationship or signal trend between the individual components or modules, but it should be clear to those skilled in the art that various related techniques such as bus connections may be employed. The above individual components or modules may be implemented by hardware facilities such as a processor, a memory, a transmitter, a receiver, etc., which is not limited in the present application.

According to the apparatus in the embodiment of the present application, the triggering conditions for relay selection or reselection by the source UE and/or the destination UE in the UE-to-UE relay scenario are specified, and the problem of how to trigger relay selection or re-selection by the source UE and/or the destination UE in the UE-to-UE relay scenario is solved.

### An Embodiment of Fifth Aspect

The embodiment of the present application provides a communication system. FIG. 10 is a schematic diagram of a communication system in the embodiment of the present application. As shown in FIG. 10, the communication system 1000 includes a first terminal equipment 1001, a second terminal equipment 1002 and a relay device 1003. For the sake of simplicity, FIG. 10 is described only with an example of one first terminal equipment, one second terminal equipment, and one relay device, but which is not limited in the embodiment of the present application.

In the embodiment of the present application, the first terminal equipment 1001, the second terminal equipment 1002, and the relay device 1003 are in the UE-to-UE relay scenario.

In some embodiments, the first terminal equipment 1001 is configured to perform the method described in the embodiment of the first aspect; the second terminal equipment 1002 is configured to perform the method described in the embodiment of the third aspect; the relay device 1003 is configured to perform the method described in the embodiment of the second aspect. Since the methods have been described in detail in the embodiments of the first aspect to the third aspect, contents therein are incorporated here and the description is omitted.

The embodiment of the present application further provides a terminal equipment. The terminal equipment may be, for example, a source UE in the UE-to-UE relay scenario or a destination UE in the UE-to-UE relay scenario, but which is not limited in the present application, and may also be other equipment.

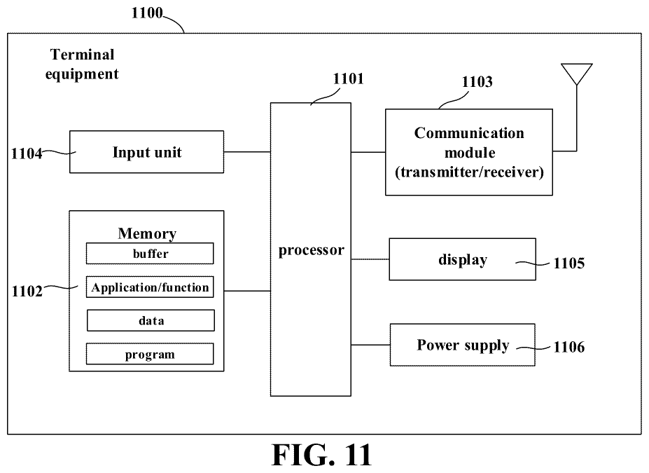

FIG. 11 is a schematic diagram of a terminal equipment in the embodiment of the present application. As shown in FIG. 11, the terminal equipment 1100 may include a processor 1101 and a memory 1102; the memory 1102 stores data and program, and is coupled to the processor 1101. It is worth noting that this figure is exemplary; other types of structures may also be used in addition to or instead of the structure to implement telecommunications functions or other functions.

For example, the processor 1101 may be configured to execute the program to implement the method as described in the embodiment of the first aspect or the third aspect.

As shown in FIG. 11, the terminal equipment 1100 may further include a communication module 1103, an input unit 1104, a display 1105, and a power supply 1106. The functions of the above components are similar to the related art, and will not be repeated here. It is worth noting that the terminal equipment 1100 is not necessarily required to include all of the components shown in FIG. 11, and the above components are not essential; in addition, the terminal equipment 1100 may further include components not shown in FIG. 11, with reference to the related art.

The embodiment of the present application further provides a relay device. The relay device may be, for example, a relay UE in the UE-to-UE relay scenario, but which is not limited in the present application, and may also be other equipment.

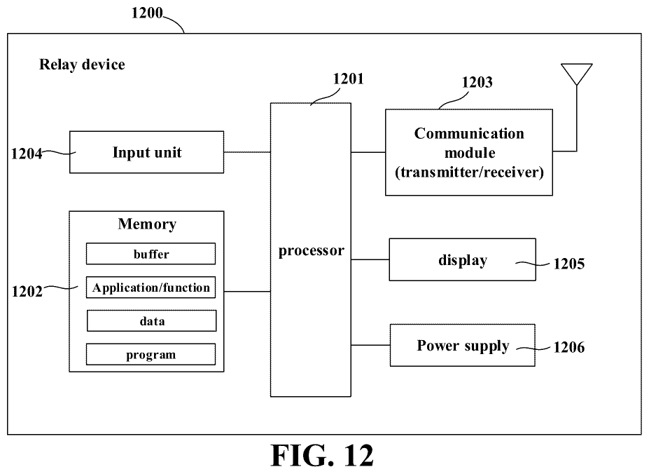

FIG. 12 is a schematic diagram of a relay device in the embodiment of the present application. As shown in FIG. 12, the relay device 1200 may include a processor 1201 and a memory 1202; the memory 1202 stores data and program, and is coupled to the processor 1201. It is worth noting that this figure is exemplary; other types of structures may also be used in addition to or instead of the structure to implement telecommunications functions or other functions.

For example, the processor 1201 may be configured to execute the program to implement the method as described in the embodiment of the second aspect.

As shown in FIG. 12, the relay device 1200 may further include a communication module 1203, an input unit 1204, a display 1205, and a power supply 1206. The functions of the above components are similar to the related art, and will not be repeated here. It is worth noting that the relay device 1200 is not necessarily required to include all of the components shown in FIG. 12, and the above components are not essential; in addition, the relay device 1200 may further include components not shown in FIG. 12, with reference to the related art.

The embodiment of the present application further provides a computer readable program which, when being executed in the terminal equipment, causes the computer to execute the method described in the embodiment of the first aspect or the third aspect in the terminal equipment.

The embodiment of the present application further provides a storage medium storing a computer readable program which causes the computer to execute the method described in the embodiment of the first aspect or the third aspect in the terminal equipment.

The embodiment of the present application further provides a computer readable program which, when being executed in the relay device, causes the computer to execute the method described in the embodiment of the second aspect in the relay device.

The embodiment of the present application further provides a storage medium storing a computer readable program which causes the computer to execute the method described in the embodiment of the second aspect in the relay device.

The above devices and methods of the present application may be implemented by hardware or by hardware combined with software. The present application relates to a computer readable program which, when being executed by a logic unit, enables the logic unit to implement the devices or components mentioned above, or enables the logic unit to implement the methods or steps described above. The logic unit is, for example, a field programmable logic unit, a microprocessor, a processor used in the computer, etc. The present application also relates to storage medium for storing the above programs, such as a hard disk, a magnetic disk, a compact disc, a DVD, a flash memory, etc.

The method/device described in conjunction with the embodiments of the present application may be directly embodied as hardware, a software module executed by the processor, or a combination of both. For example, one or more of the functional block diagrams and/or combination thereof shown in the drawing may correspond to both software modules and hardware modules of the computer program flow. These software modules can correspond to the steps shown in the drawings respectively. These hardware modules may be realized, for example, by solidifying these software modules using field programmable gate arrays (FPGA).

The software module may reside in an RAM memory, a flash memory, an ROM memory, an EPROM memory, an EEPROM memory, a register, a hard disk, a removable disk, a CD-ROM, or a storage medium in any other form known in the art. A storage medium may be coupled to a processor so that the processor can read information from the storage medium and write information to the storage medium; or the storage medium may be a constituent part of the processor. The processor and the storage medium may be located in the ASIC. The software module may be stored in the memory of the mobile terminal or in a memory card that may be inserted into the mobile terminal. For example, if a device (such as a mobile terminal) uses a large-capacity MEGA-SIM card or a large-capacity flash memory device, the software module may be stored in the MEGA-SIM card or the large-capacity flash memory device.

One or more of the functional blocks and/or combination thereof shown in the drawing may be implemented as a general-purpose processor, a digital signal processor (DSP), an application-specific integrated circuit (ASIC), a field programmable gate array (FPGA) or other programmable logic device, a discrete gate or a transistor logic device, a discrete hardware component, or any appropriate combination thereof, for performing the functions described in the present application. One or more of the functional blocks and/or combination thereof shown in the drawing may also be implemented as combination of computing devices, such as combination of DSP and a microprocessor, multiple microprocessors, one or more microprocessors combined with DSP communication, or any other such configuration.

The present application is described in combination with specific embodiments hereinabove, but a person skilled in the art should know clearly that the description is exemplary, but not limitation to the protection scope of the present application. A person skilled in the art can make various variations and modifications to the present application according to spirit and principle of the application, and these variations and modifications should also be within the scope of the present application.

With respect to the above-mentioned embodiments disclosed in the embodiment, the following supplements are further disclosed:
1. A relay selection or reselection method, wherein the method comprises:
in a UE-to-UE relay scenario, triggering, by a first terminal equipment, selection or reselection of a relay device in at least one of the following situations:
a PC5 signal strength between the first terminal equipment and a second terminal equipment being lower than a first signal strength threshold;
the first terminal equipment detecting a radio link failure (RLF) of PC5 interface between the first terminal equipment and a second terminal equipment;
an upper layer indication;
an indication from a first relay device;
a PC5 signal strength between the first terminal equipment and a second relay device being lower than a second signal strength threshold;
the first terminal equipment receiving a PC5-S link release message from the second relay device;
the first terminal equipment detecting a radio link failure (RLF) of PC5 interface between the first terminal equipment and the second relay device;
an indication from the second relay device;
an indication from a third relay device;
an indication from the second terminal equipment; and
a PC5 signal strength between the first terminal equipment and the third relay device being higher than a seventh signal strength threshold;
wherein, the first relay device is a candidate relay device, the second relay device is a current relay device via which the first terminal equipment communicates with the second terminal equipment, and the third relay device is another relay device than the current relay device via which the first terminal equipment communicates with the second terminal equipment.
2. The method according to the supplement 1, wherein the indication from the first relay device comprises:
a PC5 signal strength between the first relay device and the first terminal equipment being higher than a third signal strength threshold, and/or, a PC5 signal strength between the first relay device and the second terminal equipment being higher than a fourth signal strength threshold.
3. The method according to the supplement 2, wherein the indication from the first relay device is transmitted via a discovery-related message or a PC5 direct communication-related message or a PC5-RRC message.
4. The method according to the supplement 1, wherein the indication from the second relay device comprises at least one of the following:
the second relay device detecting an RLF of PC5 interface or PC5-RRC connection between the second relay device and the second terminal equipment;
a PC5 signal strength between the second relay device and the second terminal equipment being lower than a fifth signal strength threshold;
the second terminal equipment performing or being about to perform relay device reselection;
a PC5-S link between the second relay device and the second terminal equipment being released; and
a PC5 signal strength between the third relay device and the second terminal equipment being higher than a sixth signal strength threshold.
5. The method according to the supplement 1 or 4, wherein the indication from the second relay device is transmitted via at least one of a PC5-RRC message, PC5-S signaling, a sidelink MAC CE, and an SRAP control PDU.
6. The method according to the supplement 1, wherein the indication from the third relay device comprises:
a PC5 signal strength between the third relay device and the first terminal equipment being higher than a seventh signal strength threshold, and/or a PC5 signal strength between the third relay device and the second terminal equipment being higher than a sixth signal strength threshold.
7. The method according to the supplement 1 or 6, wherein the indication from the third relay device is transmitted via a discovery-related message or a PC5 direct communication-related message or a PC5-RRC message.
8. The method according to the supplement 1, wherein the indication from the second terminal equipment comprises at least one of the following:
end-to-end PC5-RRC connection or a PC5 link between the first terminal equipment and the second terminal equipment being released;
the second terminal equipment performing or being about to perform relay device selection or reselection; and
a PC5 signal strength between the third relay device and the second terminal equipment being higher than a sixth signal strength threshold.
9. The method according to the supplement 1 or 8, wherein the indication from the second terminal equipment is transmitted via an end-to-end PC5-RRC message or PC5-S signaling.
10. The method according to any of the supplements 1 to 9, wherein the method further comprises:
notifying, by the first terminal equipment, the second terminal equipment of a situation where selection of the relay device is triggered, or notifying the current relay device and/or the second terminal equipment of a situation where reselection of the relay device is triggered.
11. The method according to any of the supplements 1 to 9, wherein the method further comprises:
establishing connection with the second terminal equipment, by the first terminal equipment, via the selected or reselected relay device.
12. The method according to any of the supplements 1 to 11, wherein,
the signal strength thresholds are preconfigured, or are configured by a network device, or are predefined.
13. The method according to any of the supplements 1 to 11, wherein,
the upper layer is a non-access stratum of the first terminal equipment.
14. A relay selection or reselection method, wherein the method comprises:
in a UE-to-UE relay scenario, indicating, by the relay device, the first terminal equipment to trigger or perform relay selection or reselection in at least one of the following situations:
a PC5 signal strength between the relay device and the first terminal equipment being higher than a third signal strength threshold, the relay device being a candidate relay device;
a PC5 signal strength between the relay device and a second terminal equipment being higher than a fourth signal strength threshold, the relay device being a candidate relay device;
the relay device detecting an RLF of PC5 interface or PC5-RRC connection between the relay device and a second terminal equipment, the relay device being a current relay device via which the first terminal equipment communicates with the second terminal equipment;
a PC5 signal strength between the relay device and the second terminal equipment being lower than a fifth signal strength threshold, the relay device being a current relay device via which the first terminal equipment communicates with the second terminal equipment;
the relay device determining that the second terminal equipment performs or is about to perform relay device reselection, the relay device being a current relay device via which the first terminal equipment communicates with the second terminal equipment;
a PC5-S link between the relay device and the first terminal equipment being released, the relay device being a current relay device via which the first terminal equipment communicates with the second terminal equipment;
a PC5-S link between the relay device and the second terminal equipment being released, the relay device being a current relay device via which the first terminal equipment communicates with the second terminal equipment;
the relay device determining that a PC5 signal strength between another relay device and the second terminal equipment being higher than a sixth signal strength threshold, the relay device being a current relay device via which the first terminal equipment communicates with the second terminal equipment;
a PC5 signal strength between the relay device and the first terminal equipment being higher than a seventh signal strength threshold, the relay device being another relay device than a current relay device via which the first terminal equipment communicates with the second terminal equipment; and
a PC5 signal strength between the relay device and the second terminal equipment being higher than a sixth signal strength threshold, the relay device being another relay device than a current relay device via which the first terminal equipment communicates with the second terminal equipment.
15. The method according to the supplement 14, wherein the indication from the relay device is transmitted via at least one of a discovery-related message, a PC5-RRC message, PC5-S signaling, a sidelink MAC CE and an SRAP control PDU.
16. The method according to the supplement 14, wherein the method further comprises:
receiving, by the relay device, first information from the second terminal equipment, and determining that the second terminal equipment performs or is about to perform relay device reselection according to the first information.
17. The method according to the supplement 16, wherein the first information is transmitted to the relay device by the second terminal equipment via a PC5-RRC message or PC5-S signaling.
18. The method according to the supplement 14, wherein the method further comprises:
receiving, by the relay device, second information from another relay device or from the second terminal equipment, and determining that a PC5 signal strength between the another relay device and the second terminal equipment is higher than a sixth signal strength threshold according to the second information.
19. The method according to any of the supplement 14 to 18, wherein,
the signal strength thresholds are preconfigured, or are configured by a network device, or are predefined.
20. A relay selection or reselection method, wherein the method comprises:
in a UE-to-UE relay scenario, indicating, by a second terminal equipment, the first terminal equipment to trigger or perform relay selection or reselection in at least one of the following situations:
end-to-end PC5-RRC connection or a PC5 link between the first terminal equipment and the second terminal equipment being released;
the second terminal equipment performing or being about to perform relay device selection or reselection; and
a PC5 signal strength between a third relay device and the second terminal equipment being higher than a sixth signal strength threshold;
wherein the third relay device is another relay device than a current relay device via which the first terminal equipment communicates with the second terminal equipment.
21. The method according to the supplement 20, wherein the sixth signal strength threshold is preconfigured, or is configured by a network device, or is predefined.
22. The method according to the supplement 20 or 21, wherein the indication from the second terminal equipment is transmitted via a PC5-RRC message or PC5-S signaling.
23. The method according to any of the supplements 20 to 22, wherein the method further comprises:
receiving, by the second terminal equipment, third information transmitted by the first terminal equipment, the third information indicating that the first terminal equipment has triggered relay device selection or reselection.
24. The method according to any of the supplements 20 to 23, wherein the method further comprises:
establishing connection with the first terminal equipment by the second terminal equipment via the selected or reselected relay device.
25. A terminal equipment comprising a memory storing a computer program and a processor configured to execute the computer program to implement the method according to any of the supplements 1 to 13 and 20 to 24.
26. A relay device comprising a memory storing a computer program and a processor configured to execute the computer program to implement the method according to any of the supplements 14 to 19.
27. A communication system, comprising a first terminal equipment, a second terminal equipment and a relay device, wherein,
the first terminal equipment is configured to execute the method according to any of the supplements 1 to 13;
the relay device is configured to execute the method according to any of the supplements 14 to 19;
the second terminal equipment is configured to execute the method according to any of the supplements 20 to 24.

1. An apparatus, configured in a first terminal equipment, wherein the apparatus comprising:
a communicator configured to communicate a second terminal equipment via a relay device; and
processor circuitry configured to trigger a selection process of the relay device or a reselection process of the relay device in a first situation.

2. The apparatus according to claim 1, wherein
the processor circuitry triggers the selection process of the relay device in the first situation, the first situation is at least one of following situations:
the processor circuitry detects a radio link failure (RLF) of PC5 between the first terminal equipment and the second terminal equipment;
an upper layer indication;
an indication from a first relay device, the first relay device being a candidate relay device; and
a PC5 signal strength between the first terminal equipment and a second terminal equipment being lower than a first signal strength threshold.

3. The apparatus according to claim 2, wherein the indication of the first relay device comprises:
a PC5 signal strength between the first relay device and the first terminal equipment being higher than a third signal strength threshold, and/or, a PC5 signal strength between the first relay device and the second terminal equipment being higher than a fourth signal strength threshold.

4. The apparatus according to claim 2, wherein
the processor circuitry is further configured to establish connection with the second terminal equipment via the selected relay device.

5. The apparatus according to claim 2, wherein,
the upper layer is a layer above RRC of the first terminal equipment, comprising at least one of a non-access stratum, a V2X layer, and a proximity-based services layer.

6. The apparatus according to claim 1, wherein
the processor circuitry triggers the reselection process of the relay device in the first situation, the first situation is at least one of following situations:
the communicator receives a PC5-S link release message from a second relay device;
the processor circuitry detects a radio link failure (RLF) of PC5 between the first terminal equipment and the second relay device;
an upper layer indication;
an indication from the second relay device;
an indication from a third relay device;
an indication from the second terminal equipment;
a PC5 signal strength between the first terminal equipment and the third relay device being higher than a seventh signal strength threshold; and
a PC5 signal strength between the first terminal equipment and the second relay device being lower than a second signal strength threshold, wherein
the second relay device is a current relay device via which the communicator communicates with the second terminal equipment.

7. The apparatus according to claim 6, wherein the indication of the second relay device comprises at least one of the following:
the second relay device detecting an RLF of PC5 or PC5-RRC connection between the second relay device and the second terminal equipment;
a PC5 signal strength between the second relay device and the second terminal equipment being lower than a fifth signal strength threshold;
the second terminal equipment performing or being about to perform relay device reselection;
a PC5-S link between the second relay device and the second terminal equipment being released; and
a PC5 signal strength between the third relay device and the second terminal equipment being higher than a sixth signal strength threshold.

8. The apparatus according to claim 6, wherein the indication of the second relay device is transmitted via at least one of a PC5-RRC message, PC5-S signaling, a sidelink MAC CE, and an SRAP control PDU.

9. The apparatus according to claim 6, wherein the indication of the third relay device comprises:
a PC5 signal strength between the third relay device and the first terminal equipment being higher than a seventh signal strength threshold, and/or a PC5 signal strength between the third relay device and the second terminal equipment being higher than the sixth signal strength threshold.

10. The apparatus according to claim 6, wherein
the communicator is further configured to notify the current relay device and/or the second terminal equipment of the first situation where the reselection process of the relay device is triggered.

11. The apparatus according to claim 6, wherein
processor circuitry is further configured to establish connection with the second terminal equipment via the reselected relay device.

12. The apparatus according to claim 6, wherein,
the second signal strength thresholds are configured by a network device.

13. The apparatus according to claim 6, wherein,
the third relay device is another relay device than the current relay device via which the communicator communicates with the second terminal equipment.

14. A apparatus, configured in a relay device, wherein the apparatus comprises:
processor circuitry configured to, in a UE-to-UE relay scenario, indicate a first terminal equipment to trigger or perform relay selection or relay reselection in a first situation.

15. The apparatus according to claim 14, wherein
the first situation is at least one of following situations:
a PC5 signal strength between the relay device and a second terminal equipment being higher than a fourth signal strength threshold, the relay device being a candidate relay device;
the relay device detecting an RLF of PC5 interface or PC5-RRC connection between the relay device and a second terminal equipment, the relay device being a current relay device via which the first terminal equipment communicates with the second terminal equipment;
a PC5 signal strength between the relay device and the second terminal equipment being lower than a fifth signal strength threshold, the relay device being a current relay device via which the first terminal equipment communicates with the second terminal equipment;
the relay device determining that the second terminal equipment performs or about to perform relay device reselection, the relay device being a current relay device via which the first terminal equipment communicates with the second terminal equipment;
a PC5-S link between the relay device and the first terminal equipment being released, the relay device being a current relay device via which the first terminal equipment communicates with the second terminal equipment;
a PC5-S link between the relay device and the second terminal equipment being released, the relay device being a current relay device via which the first terminal equipment communicates with the second terminal equipment;
the relay device determining that a PC5 signal strength between another relay device and the second terminal equipment being higher than a sixth signal strength threshold, the relay device being a current relay device via which the first terminal equipment communicates with the second terminal equipment;
a PC5 signal strength between the relay device and the first terminal equipment being higher than a seventh signal strength threshold, the relay device being another relay device than a current relay device via which the first terminal equipment communicates with the second terminal equipment; and
a PC5 signal strength between the relay device and the second terminal equipment being higher than the sixth signal strength threshold, the relay device being another relay device than a current relay device via which the first terminal equipment communicates with the second terminal equipment.

16. The apparatus according to claim 15, wherein the indication of the relay device is transmitted via at least one of a discovery-related message, a PC5-RRC message, PC5-S signaling, a sidelink MAC CE and an SRAP control PDU.

17. The apparatus according to claim 15, further comprising:
a receiver configured to receive first information from the second terminal equipment, wherein
the processor circuitry is further configured to determine that the second terminal equipment performs or about to perform relay device reselection according to the first information.

18. The apparatus according to claim 17, wherein the first information is transmitted to the relay device by the second terminal equipment via a PC5-RRC message or PC5-S signaling.

19. The apparatus according to claim 15, further comprising:
a receiver configured to receive second information from the other relay device or from the second terminal equipment, wherein,
the processor circuitry is further configured to determine that a PC5 signal strength between the other relay device and the second terminal equipment is higher than the sixth signal strength threshold according to the second information.

20. The apparatus according to claim 15, wherein,
the signal strength thresholds are preconfigured, or are configured by a network device, or are predefined.
